(19) United States
(12) Patent Application Publication
(10) Pub. No.: US 2022/0363473 A1
(43) Pub. Date: Nov. 17, 2022

(54) TAILGATE ACTUATION SYSTEM FOR A REFUSE VEHICLE

(71) Applicant: The Heil Co., Chattanooga, TN (US)

(72) Inventors: Michael Shane Peek, Pisgah, AL (US); Andrew J. Yuds, Ringgold, GA (US); Garrett J. Eckerl, Fort Payne, AL (US); Nitesh S. Shroff, Chattanooga, TN (US)

(21) Appl. No.: 17/741,041

(22) Filed: May 10, 2022

Related U.S. Application Data
(60) Provisional application No. 63/187,080, filed on May 11, 2021.

(51) Int. Cl. B65F 3/20; B65F 3/24

(52) U.S. Cl. CPC B65F 3/20; B65F 3/24

(57) ABSTRACT

A refuse vehicle body includes an electrically actuated, rack and pinion tailgate actuation system. A tailgate is rotationally coupled to the body and configured to rotate between closed and open positions. The tailgate actuation system may be supported by the body and/or tailgate and is configured rotate the tailgate between the closed and open position. The tailgate actuation system may further optionally include a locking mechanism configured to lock and unlock the tailgate in the closed position using the same electrically powered rotary actuator that opens and closes the tailgate.

### CROSS REFERENCE TO RELATED APPLICATION

This application claims priority to U.S. Provisional Patent Application No. 63/187,080, filed on May 11, 2021, which is incorporated herein by reference in its entirety.

### FIELD OF THE INVENTION

Disclosed embodiments relate generally to refuse collection vehicles and more particularly to a tailgate actuation system for a refuse vehicle.

### BACKGROUND INFORMATION

Refuse vehicles have long serviced homes and businesses in urban, residential, and rural areas. Collected waste is commonly transported to a landfill, an incinerator, a recycling plant, or some other facility. After collection in a hopper (such as in a side or front load vehicle), the waste is generally compacted into a storage (or refuse) chamber (often in the rear of the vehicle). Such compaction reduces the volume of the refuse and increases the carrying capacity of the vehicle. An ejector (or packer) is commonly used to compact the waste. Upon opening the tailgate at a landfill (or other facility), the same ejector is also commonly used to eject the waste from the rear of the vehicle.

In various common vehicle configurations, the tailgate is hinged at the top, rear of the storage chamber and is opened and closed using linear hydraulic actuators deployed on both sides of the vehicle. The tailgate generally further includes a locking assembly to lock the tailgate closed. The locking assembly is intended to seal the storage chamber and withstand the ejector compaction forces. When emptying the refuse vehicle, the tailgate is first unlocked and opened. The ejector then pushes the waste out the rear of the vehicle.

While such refuse vehicles have long been serviceable, there is a need for further improvements. For example, hydraulic system leakage is believed to be damaging to the environment. Hydraulic systems (such as hydraulic tailgate actuators) are also sometimes expensive, difficult to service, and more prone to failure in cold temperatures. For these and other reasons, there is a developing demand for all electric or partially electric refuse vehicles that eliminates hydraulic actuators.

### SUMMARY

A refuse vehicle body includes an electrically actuated, rack and pinion tailgate actuation system. A tailgate is rotationally coupled (e.g., hinged) to the body and configured to rotate between closed and open positions. The tailgate actuation system may be supported by the body and/or tailgate and is configured to rotate the tailgate between the closed and open positions. The tailgate actuation system may further optionally include a locking mechanism configured to lock and unlock the tailgate in the closed position using the same electrically powered rotary actuator that opens and closes the tailgate.

In one embodiment, the tailgate actuation system includes a pinion supported by the body and an arcuate rack constrained to engage the pinion. One end of the rack is fixed to the tailgate. Rotation of the pinion rotates the arcuate rack to open and close the tailgate.

In another embodiment, the tailgate actuation system includes a worm gear, for example, coaxial with the tailgate hinge and a worm drive engaged with the worm gear. Rotation of the worm drive rotates the worm gear segment to open and close the tailgate.

In additional embodiments the tailgate actuation system includes an integrated tailgate locking mechanism. In one of the additional embodiments the tailgate actuation system includes a pinion supported by the body and a rack constrained to engage the pinion. The system further includes a lock configured to engage a corresponding pin on the tailgate when the tailgate is in the closed position. Rotation of the pinion translates the rack to open and close the tailgate and unlock and lock the tailgate in the closed position.

In another of the additional embodiments the tailgate actuation system includes a pinion supported by the body and first and second racks constrained to engage the pinion. Rotation of the pinion simultaneously translates the first rack to open and close the tailgate and the second rack to unlock and lock the tailgate in the closed position.

One aspect of the present disclosure features a refuse vehicle body includes a tailgate hinged to the body, the tailgate rotatable about a hinge between a closed position and an open position; a pinion supported by the body; an arcuate rack retained in engagement with the pinion, one end of the arcuate rack fixed to the tailgate; and an electric actuator configured to rotate the pinion, thereby rotating the arcuate rack to open and close the tailgate.

In some embodiments, the arcuate rack is concentric with the hinge. In some embodiments, the body further includes an arcuate channel fixed to the body, a portion of the arcuate rack deployed in the channel such that the channel is configured to retain the rack in engagement with the pinion, the channel having a radius of curvature substantially identical to a radius of curvature of the rack. In some embodiments, the pinion includes a pinion gear or a worm drive. In some embodiments, the body further includes a gear box rotationally coupling the pinion to the electric actuator. In some embodiments, an output shaft of the electric motor is substantially parallel with a side of the body, and an axis of the pinion is substantially orthogonal to the side of the body.

In some embodiments, the pinion engages one or more of an inner surface and an outer surface of the arcuate rack. In some embodiments, the pinion engages an outer surface of the arcuate rack. In some embodiments, the electric motor further includes a brake, wherein actuation and de-actuation of the brake is configured to lock and unlock the tailgate. In some embodiments, the electric actuator is a first electric actuator, the pinion is a first pinion, and the arcuate rack is a first arcuate rack, the body further including a second electric actuator, a second pinion, and a second rack, wherein the first and second electric actuators are configured to rotate the corresponding first and second pinions supported by corresponding first and second opposing sides of the body, the first and second pinions engaging the corresponding first and second arcuate racks fixed to first and second opposing sides of the tailgate.

Another aspect of the present disclosure features a refuse vehicle body includes a tailgate hinged to the body, the tailgate rotatable about a hinge between a closed position and an open position; a worm gear; a worm drive engaged with the worm gear; and an electric motor configured to rotate the worm drive, thereby rotating the worm gear to open and close the tailgate.

In some embodiments, the worm gear is a worm gear segment. In some embodiments, the worm gear is coaxial with the hinge. In some embodiments, the electric motor is fixed to the body, and the worm gear is fixed to the tailgate. In some embodiments, the electric motor is fixed to the tailgate, and the worm gear is fixed to the body. In some embodiments, the electric motor is a first electric motor, the worm gear is a first worm gear, and the worm drive is a first worm drive, the body further including a second electric motor, a second worm gear, and a second worm drive, wherein the first and second electric motors are disposed on corresponding first and second opposing sides the vehicle, the first and second electric motors engaging the corresponding first and second worm drives and the corresponding first and second worm gears, and wherein the first and second worm gears are concentric with one another. In some embodiments, the body further includes a locking assembly configured to lock the tailgate in the closed position.

Another aspect of the present disclosure features a refuse vehicle body includes a tailgate hinged to the body, the tailgate rotatable about a hinge between a closed position and an open position; a pinion supported by the body; a rack retained in engagement with the pinion, the rack being rotationally coupled with the tailgate; a pin on the tailgate; a lock configured to engage the pin to lock the tailgate in the closed position; and an electric actuator configured to rotate the pinion and move the rack to: (i) open and close the tailgate and (ii) lock and unlock the tailgate in the closed position in response to rotation of the pinion.

In some embodiments, the electric actuator is configured to: (i) move the rack to disengage the lock from the pin and rotate the tailgate towards the open position in response to rotation of the pinion in a first direction, and (ii) move the rack to rotate the tailgate towards the closed position and engage the lock with the pin when the tailgate is in the closed position in response to rotation of the pinion in a second opposite direction.

In some embodiments, the lock includes a hook configured to engage the pin. In some embodiments, the hook is fixed to or integral with the rack and is configured to engage the pin when the tailgate is in the closed position. In some embodiments, the body further includes a locking member rotationally coupled with the body, the locking member including the hook. In some embodiments, the rack further includes a tab configured to rotate the locking member into engagement with the pin when the tailgate is in the closed position. In some embodiments, the body further includes a channel fixed to the body, a portion of the rack deployed in the channel such that the channel is configured to retain the rack in engagement with the pinion.

In some embodiments, the electric actuator is a first electric actuator, the pinion is a first pinion, the rack is a first rack, the pin is a first pin, and the lock is a first lock, the body further including a second electric actuator, a second pinion, a second rack, a second pin, and a second lock, wherein the first and second electric actuators are coupled to the corresponding first and second pinions that are supported by corresponding first and second opposing sides of the body, the first and second pinions engaging the corresponding first and second racks that are rotationally coupled to corresponding first and second opposing sides of the tailgate, and wherein the tailgate includes the first and second pins configured for engagement with the corresponding first and second locks.

Another aspect of the present disclosure features a refuse vehicle body includes a tailgate hinged to the body, the tailgate rotatable about a hinge between a closed position and an open position; a pin deployed on the tailgate; a pinion rotationally coupled with the body; a pair of racks configured to engage the pinion, the pair of racks including a first rack configured to open and close the tailgate and a second rack configured to lock and unlock the tailgate in the closed position, the second rack including a lock that engages the pin and locks the tailgate in the closed position; an electric actuator configured to: (i) rotate the pinion, (ii) move the first rack to open and close the tailgate in response to rotation of the pinion, and (iii) move the second rack to lock and unlock the tailgate in the closed position in response to rotation of the pinion.

In some embodiments, the electric actuator is configured to: (i) move the second rack to disengage the lock from the pin and move the second rack to rotate the tailgate towards the open position in response to rotation of the pinion in a first direction, and (ii) move the first rack to rotate the tailgate towards the closed position and move the second rack to engage the lock with the pin when the tailgate is in the closed position in response to rotation of the pinion in a second opposite direction. In some embodiments, the body further includes a push rod deployed between and mechanically coupling the first rack and the tailgate, a first end of the push rod pivotably coupled to the tailgate and a second end of the push rod pivotably coupled to the first rack.

In some embodiments, the first and second racks include first and second linear racks engaging diametrically opposing sides of the pinion. In some embodiments, the lock includes a hook fixed to or integral with one end of the second rack. In some embodiments, the electric actuator is a first electric actuator, and the pinion is a first pinion, the body further includes a second electric actuator and a second pinion, wherein the first and second electric actuators are coupled to the corresponding first and second pinions that are supported by corresponding first and second opposing sides of the body, and wherein the first and second pinions are configured to engage the corresponding first and second racks, thereby opening and closing the tailgate and locking and unlocking the tailgate.

Another aspect of the present disclosure features a refuse vehicle including a chassis; and any of the refuse vehicle bodies disclosed herein on the chassis. In some embodiments, the body further includes a hopper configured to receive refuse; a storage container configured to store compacted refuse; and an ejector movable in the body and configured to compact refuse in the storage container when the tailgate is in the closed position and eject refuse from the storage container when the tailgate is in the open position.

In some embodiments, the body further includes an ejector movable in the body and configured to compact refuse in the storage container when the tailgate is in the closed position and eject refuse from the storage container when the tailgate is in the open position.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example refuse vehicle employing a disclosed tailgate actuation system.

FIGS. 2A and 2B (collectively FIG. 2) depict a rear portion of a refuse vehicle employing a tailgate actuation system that rotates the tailgate between closed (2A) and opened (2B) positions.

FIGS. 3A, 3B, and 3C (collectively FIG. 3) depict a rear portion of a refuse vehicle employing an alternative tailgate actuation system that rotates the tailgate between closed (3A and 3B) and opened (3C) positions.

FIGS. 4A and 4B (collectively FIG. 4) depict a rear portion of a refuse vehicle employing another alternative tailgate actuation system that rotates the tailgate between closed (4A) and opened (4B) positions.

FIGS. 5A and 5B (collectively FIG. 5) depict a rear portion of a refuse vehicle employing yet another alternative tailgate actuation system that rotates the tailgate between closed (5A) and opened (5B) positions.

FIGS. 6A, 6B, and 6C (collectively FIG. 6) depict a rear portion of a refuse vehicle employing still another alternative tailgate actuation system that rotates the tailgate between closed (6A and 6B) and opened (6C) positions.

### DETAILED DESCRIPTION

A refuse vehicle body includes an electrically actuated, rack and pinion tailgate actuation system. The tailgate actuation system is supported by the vehicle body and/or tailgate and is configured to rotate the tailgate between open and closed positions. The tailgate actuation system may further optionally include an integrated locking mechanism configured to lock and unlock the tailgate in the closed position using the same electrically powered rotary actuator that opens and closes the tailgate.

The disclosed embodiments may advantageously provide an all-electric tailgate actuation system and may therefore obviate the need for hydraulic actuators. Moreover, certain ones of the disclosed embodiments do not require conversion from rotary to linear motion and may therefore advantageously reduce the energy requirements to open and close the tailgate. Certain other embodiments may further include an integrated tailgate locking system that locks the tailgate closed using the same electric actuator used to open and close the tailgate. The disclosed systems may therefore provide improved reliability and further improved energy efficiency.

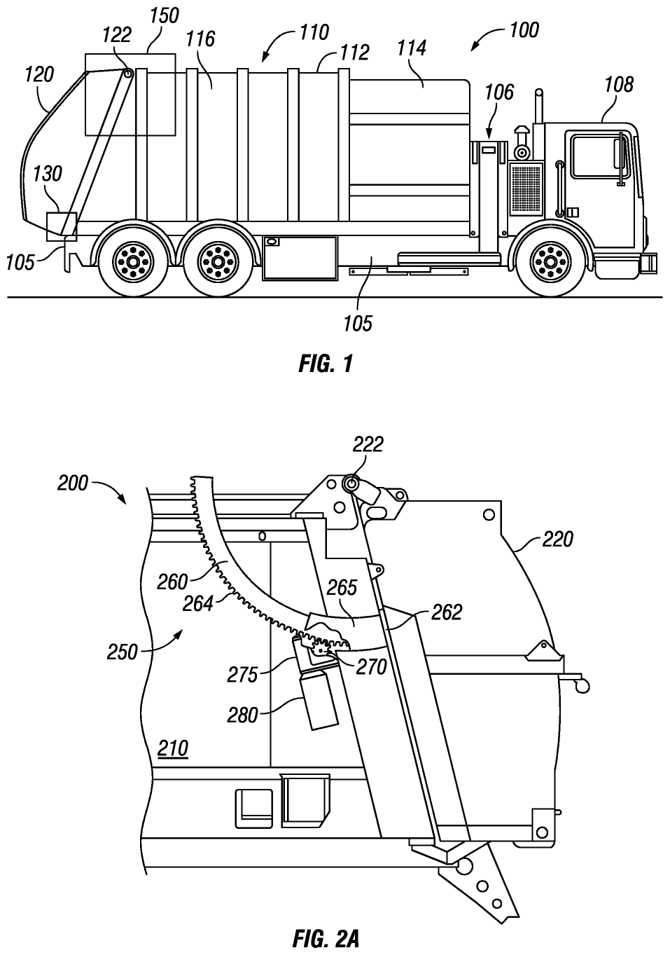

FIG. 1 depicts an example refuse vehicle 100 employing a disclosed tailgate actuation system 150. The depicted vehicle 100 includes a vehicle body 110 and a cab 108 deployed on a chassis (or frame) 105. The vehicle body 110 houses a refuse container 112, which in the depicted embodiment includes a hopper 114 and a storage container 116 (with the hopper 114 located between the storage container 116 and the cab 108). A tailgate 120 is deployed on a rearward facing end of the body 110 and is configured to open and close the refuse container 112 (e.g., the storage container 116) to the outside world. For example, the tailgate 120 may be pinned or hinged at 122 such that the tailgate 120 rotates about the hinge 122 between closed (as depicted on FIG. 1) and open positions.

It will be understood that the disclosed embodiments are not limited to any particular type or style of refuse vehicle. The vehicle may include a sanitation truck, a recycling truck, a garbage truck, a waste collection truck, etc. In FIG. 1, the depicted vehicle 100 is configured as a side loading refuse vehicle; including a side loader assembly 106 configured to load refuse into the hopper from alongside the vehicle. The disclosed embodiments are, of course, not limited in regard to any refuse loading configuration. For example, while not depicted, the vehicle may also be configured as a front loading refuse vehicle including a front loading assembly configured to load refuse from the front of the vehicle. The vehicle may also be configured as a rear loading refuse vehicle, for example, configured for automatic or manual loading of refuse at the rear of the vehicle. Those of ordinary skill will readily appreciate that tailgates in front and side loading vehicles may be similarly constructed, while the tailgate in a rear loading vehicle is generally heavier and includes a built in hopper and compaction unit. Notwithstanding these differences, the disclosed tailgate actuation systems may be suitably configured for use in a rear load vehicle.

It will be understood that in the disclosed embodiments, the vehicle may optionally include a tailgate locking mechanism (depicted schematically at 130 in FIG. 1) to lock the tailgate in the closed position. Locking mechanism 130 is also referred to herein as a secondary locking mechanism as it may provide a secondary or redundant locking function. The locking mechanism 130 may be advantageously configured to secure the tailgate 120 in the closed position such that it can withstand compaction forces imparted by a compactor such as an ejector (also commonly referred to in the industry as an ejector panel, a packer, or a packer panel among other terms) or an auger (which are not depicted).

The locking mechanism 130 may include substantially any suitable mechanism known to those of ordinary skill in the art. For example, the locking mechanism may include a manual locking mechanism including a threaded member or a pin deployed on the body (or tailgate) that engages a corresponding aperture on the tailgate (or body). The locking mechanism may alternatively include a powered mechanism in which a pin, screw, or bar engages a corresponding aperture or slot. Such mechanisms may be powered, for example, via hydraulic, electric, or pneumatic power and may be advantageously controlled from the cab.

When a locking mechanism (or secondary locking mechanism) is employed it is generally unlocked prior to opening the tailgate 120. Such unlocking may be initiated, for example, by the vehicle operator. The refuse vehicle 100 may alternatively be configured to automatically unlock the locking mechanism 130 when the tailgate opening procedure is initiated.

As described in more detail below, certain disclosed embodiments may employ an electrically powered tailgate actuation system that includes an integrated locking mechanism that both closes and locks the tailgate (or unlocks and opens the tailgate). As described in more detail below, these embodiments may be advantageous in that they tend not to require a secondary locking system. They may further provide improved energy efficiency and reliability.

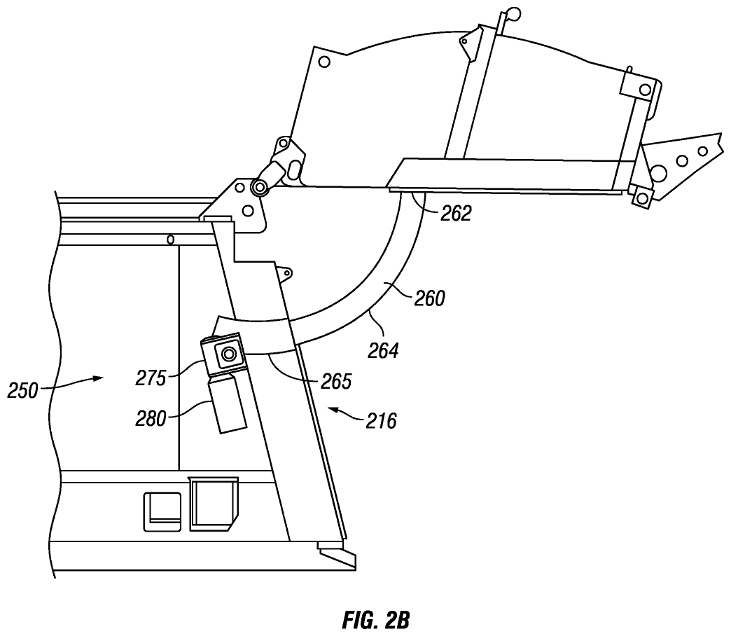

Turning now to FIGS. 2A and 2B, a rear portion of refuse vehicle 200 is depicted in side view with the tailgate 220 in the closed position (2A) and the fully open position (2B). Refuse vehicle 200 includes an electrically powered tailgate actuation system 250 configured to open and close the tailgate 220. The system includes at least one arcuate (arc-shaped) rack 260 driven by an electric actuator 280 (e.g., an electric motor) and a corresponding pinion 270. The motor 280 and pinion 270 may be mounted, for example, on an exterior surface of the body 210. In the depicted embodiment, the arcuate rack 260 is concentric with the tailgate hinge 222. One end 262 of the rack 260 may be rigidly fixed to the tailgate 220 such that the rack 260 rotates with the tailgate 220 as it opens and closes. The rack 260 may be further deployed in a corresponding arcuate channel 265. The channel 265 may be fixed to the body 210 and concentric with hinge 222. The channel 265 is intended to constrain (retain) the arcuate rack 260 in engagement with the pinion 270 while also allowing pinion driven rotation of the rack to open and close the tailgate. It will be appreciated that the channel may include internal rollers and/or wear pads (not shown) to promote low friction, slidable engagement with the arcuate rack 260.

In the depicted embodiment pinion 270 includes a circular gear having outer teeth that are engaged with corresponding teeth on an outer diameter surface 264 of the arcuate rack 260. In an alternative deployment (not depicted), the pinion may engage teeth on an inner diameter surface of the rack 260. The disclosed embodiments are not limited in regard to which rack surface is engaged by the pinion. Moreover, the pinion 270 may alternatively include a worm drive configured to engage corresponding teeth on the rack.

With continued reference to FIG. 2, the actuation system 250 may further include one or more additional gears, for example, deployed in an optional gear box 275 coupling the motor 280 and the pinion 270. An optional gear box 275 may be employed, for example, to slow the output speed of the motor 280 and/or rotationally couple the motor shaft (not shown) to the pinion 270 (e.g., to couple a motor shaft that is parallel with a side of the vehicle to a pinion with an axis that is orthogonal to the vehicle side). Those of ordinary skill will be readily able to select or configure a suitable gear box when required.

To open the tailgate, an optional locking mechanism 130 (FIG. 1) may be unlocked (e.g., via manual or automatic actuation as described above). The electric motor 280 then rotates the pinion 270, which in turn rotates (translates) the arcuate rack 260 in the channel 265 and thereby opens the tailgate 220. Rotation of the pinion may continue until the tailgate is in a fully opened position (FIG. 2B). The arcuate rack 260 may be of adequate length to fully open the tailgate 220 without disengaging from the pinion 270. An optional motor brake may be engaged to secure the tailgate in the open position. Substantially any suitable motor brake may be employed, for example, including a DC spring set brake, an electrically set brake, or a permanent magnet set brake.

To close the tailgate 220, the electric motor 280 is reversed, rotating the pinion 270 in the opposite direction, which in turn rotates (translates) the arcuate rack 260 in the channel 265 and closes the tailgate 220. The motor 280 may be configured (e.g., with sufficient torque) to pull the tailgate securely closed and seal the storage container 216. The optional motor brake may again be engaged to lock the tailgate in the closed position. An optional secondary locking mechanism 130 (FIG. 1) may also be actuated to lock the tailgate in the closed position.

While not depicted in the side views shown on FIG. 2, it will be appreciated that refuse vehicle 200 may include symmetric actuation systems 250 deployed on opposing sides of the vehicle body 210 (e.g., on the driver and passenger sides of the body). In other words, the refuse vehicle 200 may include first and second electric motors deployed on opposing sides of the body engaging corresponding first and second pinions and first and second substantially identical arcuate racks. The motors may be synchronized to simultaneously rotate (translate) the arcuate racks and thereby open and close the tailgate 220. Those of ordinary skill will readily appreciate that a vehicle employing symmetric systems may provide better support and stability for the tailgate 220 and thereby reduce stress in the hinge and reduce the likelihood of twisting when opening and/or closing (with a trade-off of increased cost and complexity).

It will further be appreciated that use of an arcuate rack 260 (e.g., as depicted and described above) may advantageously reduce the complexity and increase the stability of the overall tailgate system. For example, as described above, the arcuate rack 260 may be rigidly fixed to the tailgate 220 (in contrast to a pivoting or rotating coupling required when using a linear actuator). Moreover, the use of an arcuate rack 260 obviates the need for linkages that are sometimes required when converting linear motion to rotational motion.

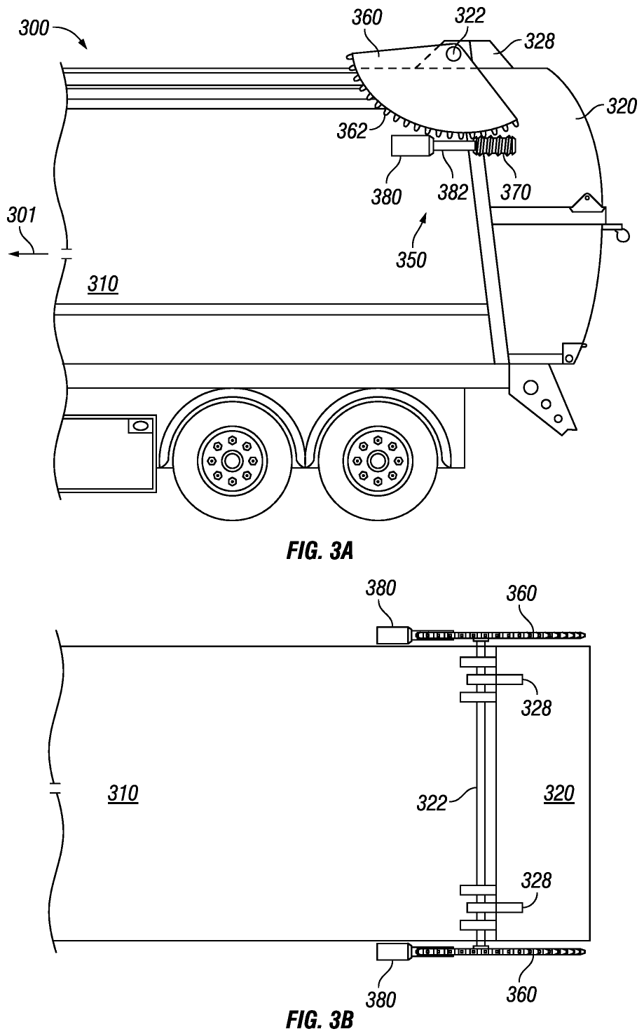

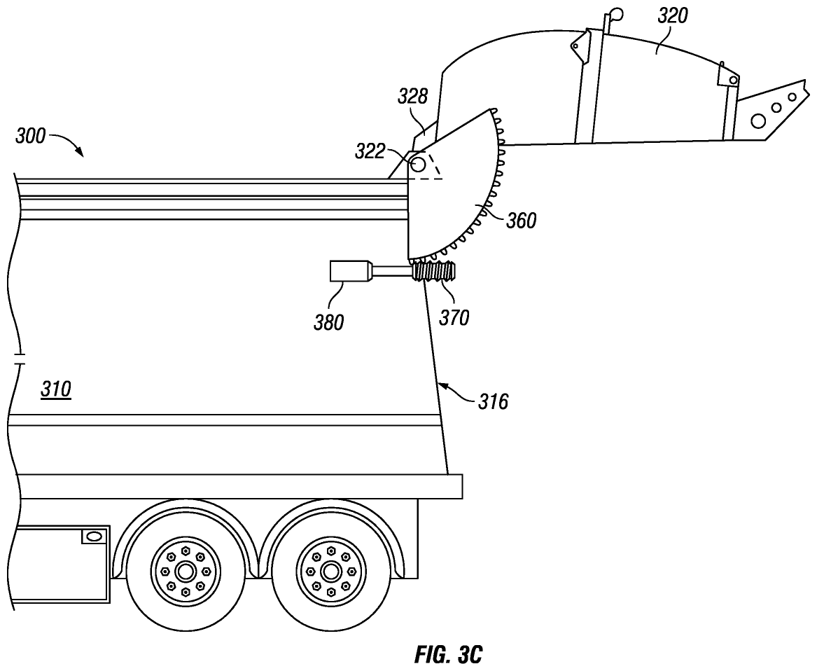

Turning now to FIGS. 3A, 3B, and 3C, a rear portion of an alternative refuse vehicle 300 is shown. FIGS. 3A and 3B depict side and top views of the vehicle 300 with the tailgate 320 in the closed position and FIG. 3C depicts a side view with the tailgate 320 in a fully open position. Refuse vehicle 300 includes an electrically powered tailgate actuation system 350 configured to open and close the tailgate 320. The system includes a worm gear 360 (e.g., a worm gear segment) driven by an electric motor 380 and a corresponding worm drive 370. The motor 380 may be mounted, for example, on an exterior surface of the body 310 with the motor driveshaft 382 substantially parallel with an axis 301 of the vehicle 300.

The worm drive 370 is configured to engage teeth 362 on the worm gear segment 360 (e.g., on an outer diameter surface as depicted). The worm drive 370 may be mounted directly to the motor shaft 382 and may therefore advantageously eliminate the need to employ a gearbox between the motor 380 and the worm drive 370 as described above with respect to FIG. 2. Use of a low speed electric motor may be further advantageous and eliminate the need for an intervening gear box.

In the depicted embodiment, the worm gear segment 360 is concentric with the tailgate hinge (or shaft) 322 and may be fixed to the hinge 322 and/or to the tailgate 320 such that it rotates with the tailgate 320 as it opens and closes. The tailgate 320 may be rotationally fixed to the shaft 322 via tailgate brackets 328. For example, the tailgate brackets may be welded to the both the tailgate 320 and the shaft 322.

To open the tailgate, an optional locking mechanism 130 (FIG. 1) may be unlocked (e.g., via manual or automatic actuation as described above). The electric motor 380 then rotates the worm drive 370 which in turn rotates the worm gear segment 360 and thereby rotates the tailgate 320 to the fully open position (FIG. 3C). An optional motor brake (not depicted) may be engaged to secure the tailgate in the open position (e.g., as described above).

To close the tailgate, the electric motor 380 is reversed, rotating the worm drive 370 in the opposite direction, which in turn rotates the worm gear segment 370 and shaft 322 to close the tailgate 320 (or allows the tailgate to rotate closed under its own weight). The motor 380 may be configured (e.g., with sufficient torque) to pull the tailgate securely closed and seal the storage container 316. The optional motor brake may again be engaged to lock the tailgate in the closed position. An optional secondary locking mechanism 130 may also be actuated to lock the tailgate in the closed position.

With continued reference to FIG. 3B, the depicted vehicle includes symmetric tailgate actuation systems deployed on opposing sides of the vehicle (each system including the above described motor, worm drive, and worm gear segment). It will be appreciated that the disclosed embodiments are not limited in this regard. In an alternative embodiment, the vehicle may include only a single system 350 (having a single motor, worm drive, and worm gear segment) deployed on one side of the vehicle. In such embodiments, the system may be configured to provide sufficient torque to open and close (raise and lower) the tailgate with a single motor.

In another alternative configuration, the electric motor(s) 380 and corresponding worm drive(s) 370 may be fixed to the tailgate 320 and the worm gear segment(s) 360 may be fixed to the vehicle body 310 (e.g., welded or bolted to the side of the body). In such an embodiment, actuation of the electric motor rotates the worm drive (and motor) around the periphery of the stationary worm gear segment (stationary with respect to the body), thereby opening and closing the tailgate 320.

With continued reference to FIG. 3, it will be understood that the worm gear segment 360 may optionally include mechanical stops (not depicted) on either or both end(s) to prevent the worm drive 370 from advancing past the end of the segment. The motor 380 may also be configured with control intelligence that prevents it from advancing past certain predetermined positions on the worm gear segment (e.g., the control intelligence may be programmed to rotate the motor a predetermined number of rotations to open and close the tailgate).

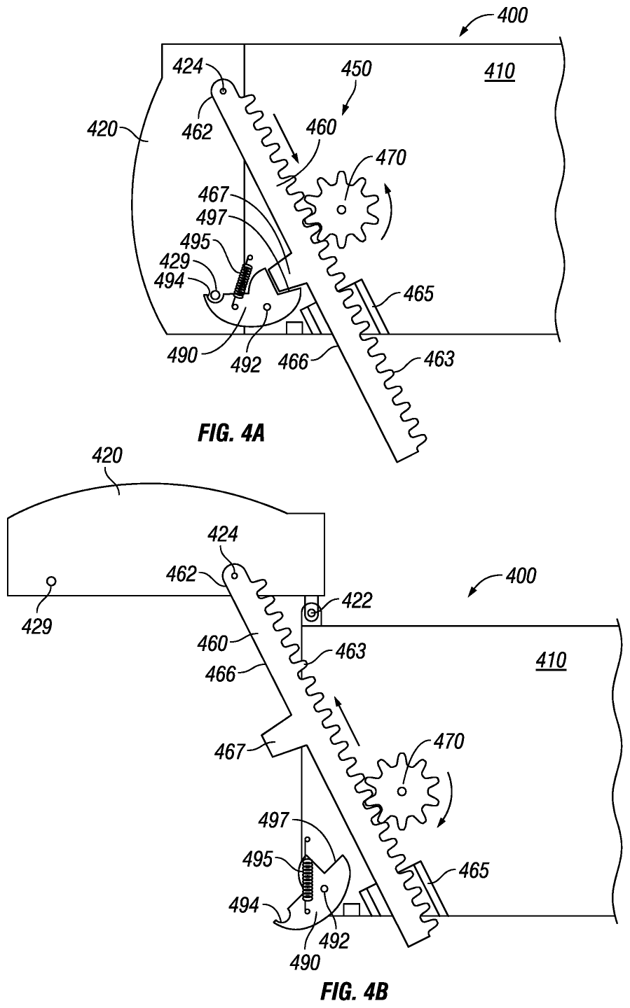

FIGS. 4A-6B depict rear portions of alternative refuse vehicles 400, 500, and 600 including alternative tailgate actuation systems 450, 550, and 650. Each of these systems includes an electrically powered rotary actuator (not depicted), a pinion, at least one rack (e.g., a linear rack), and an integrated tailgate locking mechanism configured to lock the tailgate in the closed position (when the tailgate is fully closed). The disclosed locking mechanisms are actuated using the same electrically powered rotary actuator that opens and closes the tailgate and may therefore simplify tailgate functionality. Moreover, the disclosed embodiments may be configured to secure the tailgate against routine refuse compaction forces and may therefore obviate the need for a secondary tailgate locking mechanism (thereby potentially reducing weight and cost of the vehicle).

Turning now to FIGS. 4A and 4B, a rear portion of refuse vehicle 400 is depicted with the tailgate 420 in the closed position (4A) and the fully open position (4B). Refuse vehicle 400 includes an electrically powered tailgate actuation system 450 configured to open and close the tailgate 420. The system includes a rack 460 (e.g., a linear rack) engaged with and driven by a pinion 470 and a corresponding rotary actuator (not depicted). The rotary actuator may include an electric motor, for example, as described above with respect to FIGS. 2 and 3. One end 462 of the rack 460 is rotationally coupled to the tailgate 420, for example, via a pin 424. The rack 460 may be further deployed in a corresponding channel 465 (e.g., a C-channel) that may be fixed to the body 410 or the chassis. The channel 465 is intended to constrain the rack in engagement with the pinion 470 while allowing pinion driven translation of the rack. The channel may include internal rollers and/or wear pads (not shown) to promote low friction slidable engagement with the rack.

The depicted system 450 further includes a locking member 490 rotationally coupled (e.g., pinned) to the body 410, for example, at a pin or hinge point 492. The locking member is configured to rotate between locked and unlocked positions in which a hook 494 is engaged and disengaged with a corresponding pin 429 on the tailgate 420. In the example embodiment depicted, the locking member 490 includes an integral hook 494 sized and shaped to engage the corresponding tailgate pin 429. Engagement of the hook 494 and pin 429 locks and secures the tailgate 420 in the closed position. The hook 494 and pin 429 may be advantageously configured (e.g., of sufficient size and strength) to provide a secure lock capable of withstanding compaction forces during routine refuse compaction. Such embodiments may advantageously obviate the need for a secondary locking mechanism. The example embodiment depicted further includes a tab 467 on a back side 466 of the linear rack 460 (the side opposing the teeth 463) that engages a corresponding engagement surface 497 on the locking member 490. Engagement of the tab 467 with surface 497 is intended to maintain the locking member 490 in the locked position.

The tailgate 420 may be unlocked and opened by rotating the pinion 470 (in the clockwise direction in the depicted view). When the tailgate 420 is closed and locked (FIG. 4A), initial translation of the rack 460 disengages tab 467 from engagement surface 497. A compression spring 495 rotationally biases the locking member towards the unlocked position (such that hook 494 disengages from pin 429) and thereby unlocks the tailgate 420. Continued rotation of the pinion 470 (via the rotary actuator) translates the linear rack 460 towards the tailgate (up and to the left in the depicted view) thereby rotating the tailgate 420 about hinge 422 to the fully opened position (as depicted on FIG. 4B). A motor brake (not depicted) may be employed as described above to hold the tailgate in the open position.

The tailgate 420 may be closed and locked by rotating the pinion 470 in the opposite direction (in the counter clockwise direction in the depicted view). Rotation of the pinion 470 translates the linear rack 460 towards the body 410 (down and to the right in the depicted view) thereby rotating the tailgate 420 about hinge 422 towards the closed position. As the tailgate 420 approaches the closed position tab 467 contacts engagement surface 497. Continued rotational actuation of the pinion 470 causes the tab 467 to rotate locking member 490 from the unlocked position towards the locked position (against the bias of compression spring 495). Rotational actuation of the pinion continues until the locking member 490 is in the fully locked position with hook 494 engaging pin 429 to securely lock the tailgate in the closed position.

While not depicted in the side views shown on FIG. 4, it will be appreciated that refuse vehicle 400 may include symmetric actuation systems 450 deployed on opposing sides of the vehicle body 410 (e.g., on the driver and passenger sides of the body). In other words, the refuse vehicle 400 may include first and second electric actuators on opposing sides of the body engaging corresponding first and second pinions and first and second racks. The actuators may be synchronized to simultaneously translate the racks and thereby open and close (as well as unlock and lock) the tailgate 420.

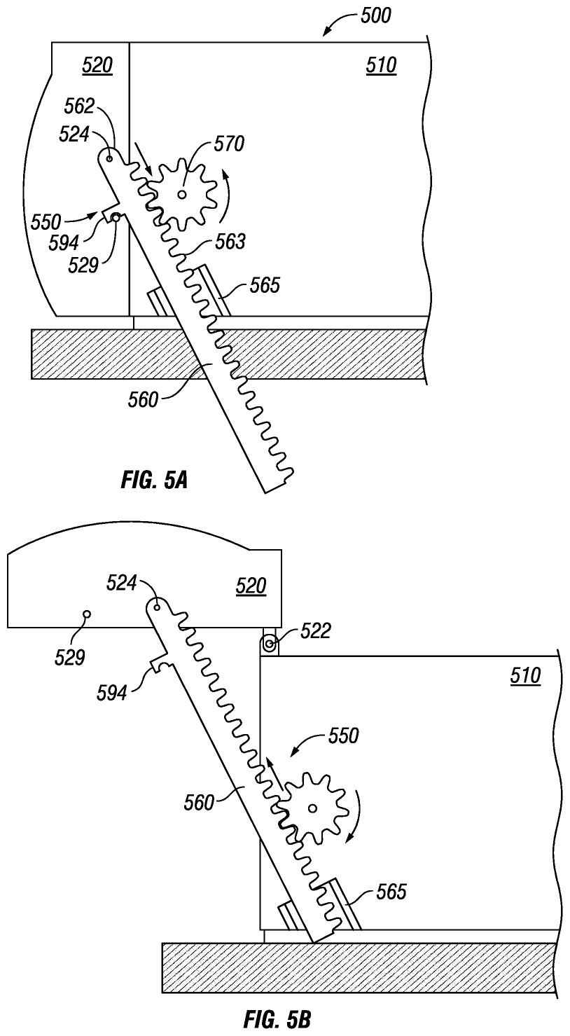

Turning now to FIGS. 5A and 5B, a rear portion of refuse vehicle 500 is depicted with the tailgate 520 in the closed position (5A) and the fully open position (5B). Refuse vehicle 500 includes an electrically powered tailgate actuation system 550 configured to open and close the tailgate 520. System 550 is similar to system 450 (FIG. 4) in that it includes a rack 560 (e.g., a linear rack) engaged with and driven by a pinion 570 and a corresponding rotary actuator (not depicted). One end 562 of the rack 560 is rotationally coupled to the tailgate 520, for example, via a pin 524. The rack 560 may be further deployed in a corresponding channel 565 (e.g., a C-channel) that may be fixed to the body 510 and as described above, may be configured to constrain the rack 560 in engagement with the pinion 570 while allowing pinion driven translation of the rack 560. The channel 565 may include internal rollers and/or wear pads (not depicted) to promote low friction slidable engagement with the rack.

The system 550 further includes a locking hook 594 on a back side of the rack (the side opposing the teeth 563). The locking hook 594 is configured to engage and disengage with a corresponding pin 529 on the tailgate 520 to lock and unlock the tailgate 520 in the closed position. The pin 529 and hook 594 may be advantageously configured (e.g., of sufficient size and strength) to provide a secure lock capable of withstanding compaction forces during routine refuse compaction. Such embodiments may advantageously obviate the need for a secondary locking mechanism. It will be understood that the pin may alternatively be located on the body 510. In such an embodiment, the hook 594 may be shaped to restrict translation of the rack and thereby lock the tailgate in the closed position.

The tailgate 520 may be unlocked and opened by rotating the pinion 570 (in the clockwise direction in the depicted view). When the tailgate 520 is closed and locked (FIG. 5A), the initial translation of the rack 560 disengages the hook 594 from the pin 529 and thereby unlocks the tailgate 520. Continued rotation of the pinion 570 translates the linear rack 560 towards the tailgate 520 (up and to the left in the depicted view) thereby rotating the tailgate 520 about hinge 522 to the fully opened position (as depicted on FIG. 5B). A motor brake (not depicted) may be employed as described above to hold the tailgate 520 in the open position.

The tailgate 520 may be closed and locked by rotating the pinion 570 in the opposite direction (in the counter clockwise direction in the depicted view). Rotation of the pinion 570 translates the linear rack 560 towards the body 510 (down and to the right in the depicted view) thereby rotating the tailgate 520 about hinge 522 towards the closed position. As the tailgate approaches the closed position hook 594 begins to engage pin 529. Continued rotational actuation of the pinion 570 rotates the tailgate 520 to the closed position and seats the pin 529 in the hook 594 and locks the tailgate 520 in the closed position.

While not depicted in the side views shown on FIG. 5, it will be appreciated that refuse vehicle 500 may include symmetric actuation systems 550 deployed on opposing sides of the vehicle body 510 (e.g., on the driver and passenger sides of the body). In other words, the refuse vehicle 500 may include first and second electric actuators on opposing sides of the body engaging corresponding first and second pinions and first and second racks. The motors may be synchronized to simultaneously translate the racks and thereby open and close (as well as unlock and lock) the tailgate 520.

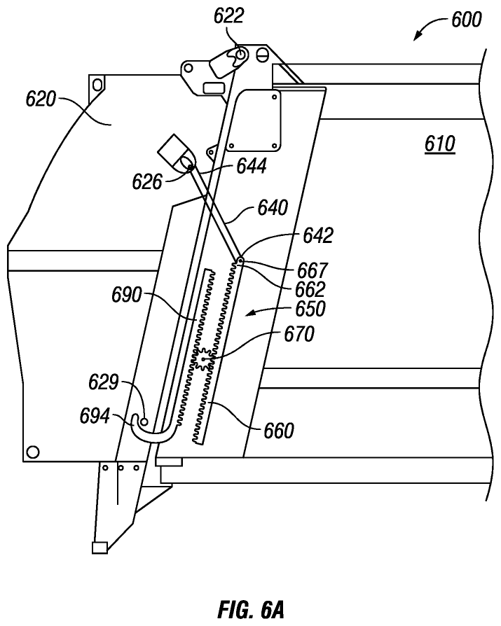

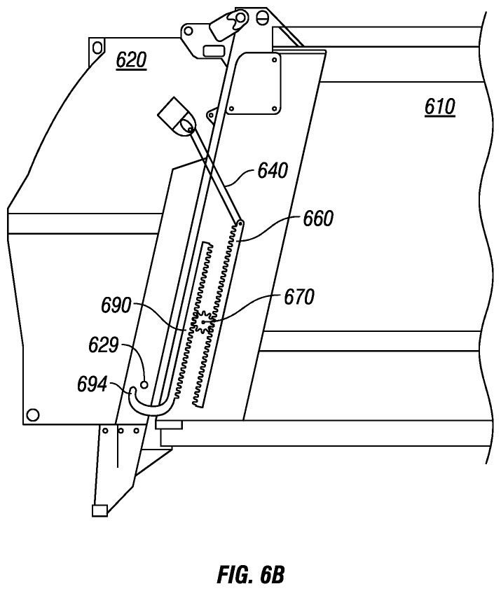

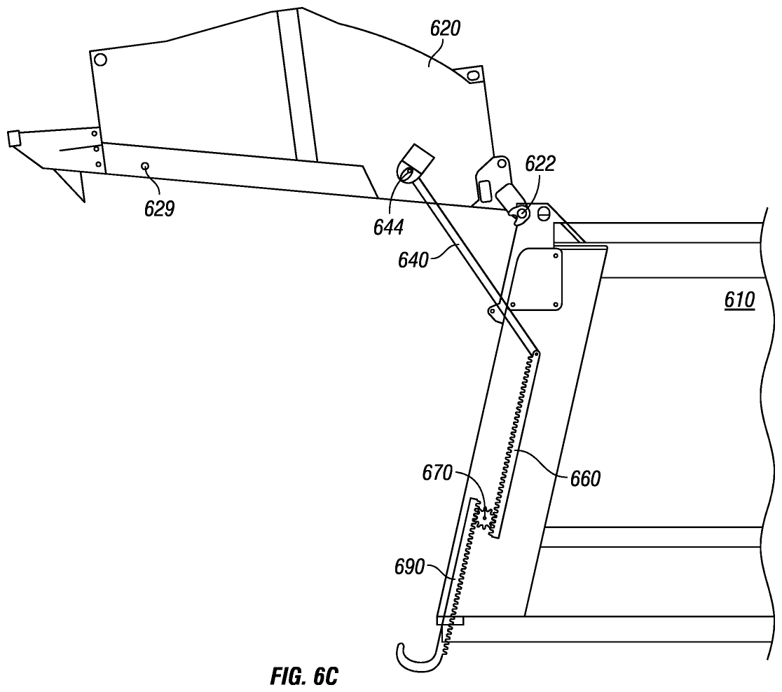

Turning now to FIGS. 6A, 6B, and 6C, a rear portion of refuse vehicle 600 is depicted with the tailgate 620 closed and locked (6A), closed and unlocked (6B), and fully open (6C). Refuse vehicle 600 includes an electrically powered tailgate actuation system 650 configured to both open and close and unlock and lock the tailgate 620. The system 650 includes first and second racks 660 and 690 (e.g., linear racks) engaged with and driven by a pinion 670 and a corresponding rotary actuator (not depicted). The racks 660 and 690 may be engaged, for example, with diametrically opposing sides of the pinion 670. While not depicted, it will be understood that the racks 660 and 690 may be constrained (e.g., via a channel or corresponding channels as described above with respect to FIGS. 4 and 5). Such constraint is intended to secure the racks 660 and 690 in engagement with the pinion 670 while allowing pinion driven translation of each rack. The rotary actuator may include an electric motor, for example, as described above with respect to FIGS. 2 and 3.

One end 662 of the first rack 660 is coupled to the tailgate 620 (e.g., via a push bar). In the depicted embodiment, an upper end 662 of the rack 660 is coupled to (e.g., fixed to) one end 642 of a push bar 640, the other end 644 of which is rotationally coupled (as depicted at 667) with the tailgate 620 (e.g., via a pin 626). The second rack 690 includes a hook 694 (e.g., fixed to or integral with the rack 690 in the depicted embodiment). The hook 694 is configured to engage a corresponding pin 629 on the tailgate 620 and thereby lock the tailgate in the closed position.

The tailgate 620 may be unlocked and opened by rotating the pinion 670 (in the counter clockwise direction in the depicted view). When the tailgate 620 is closed and locked (FIG. 6A), rotation of the pinion simultaneously translates both racks 660 and 690 (in opposing directions in the depicted embodiment). Translation of the second rack 690 disengages the hook 694 from the pin 629 and unlocks the tailgate 620 (FIG. 6B). It will be appreciated that the rotational coupling between the push bar 640 and the tailgate 620 may include a linkage or other mechanism (not shown) that allows the first rack 660 to translate a small distance (the distance required to disengage hook 694 from pin 629) before imparting force to the tailgate 620.

Continued rotation of the pinion 670 further translates the racks 660 and 690 thereby transferring force through the push bar 640 to rotate the tailgate 620 about hinge 622 to the fully opened position. As described previously, a motor brake (not depicted) may be employed to hold the tailgate in the open position.

The tailgate 620 may be closed and locked by rotating the pinion 670 in the opposite direction (in the clockwise direction in the depicted view). Rotation of the pinion 670 simultaneously translates both racks 660 and 690. Downward translation of the first rack 660 rotates tailgate 620 towards the closed position (or allows the tailgate 620 to rotate towards the first position under its own weight). As the tailgate 620 approaches the closed position hook 694 begins to engage pin 629. Continued rotational actuation of the pinion 670 rotates the tailgate 620 to the closed position and seats the pin 629 in the hook 694 thereby locking the tailgate 620 in the closed position.

While not depicted in the side views shown on FIG. 6, it will be appreciated that refuse vehicle 600 may include symmetric actuation systems 650 deployed on opposing sides of the vehicle body 610 (e.g., on the driver and passenger sides of the body). In other words, the refuse vehicle 600 may include first and second electric actuators on opposing sides of the body engaging corresponding first and second pinions and first and second pairs of racks. The motors may be synchronized to simultaneously translate the racks and thereby open and close (as well as unlock and lock) the tailgate 620.

Although multiple embodiments of a tailgate actuation system for a refuse vehicle have been described in detail, it should be understood that various changes, substitutions and alternations can be made herein without departing from the spirit and scope of the disclosure as defined by the appended claims.

What is claimed is:

1. A refuse vehicle body comprising:
a tailgate hinged to the body, the tailgate rotatable about a hinge between a closed position and an open position;
a pinion supported by the body;
an arcuate rack retained in engagement with the pinion, one end of the arcuate rack fixed to the tailgate; and
an electric actuator configured to rotate the pinion, thereby rotating the arcuate rack to open and close the tailgate.

2. The refuse vehicle body of claim 1, wherein the arcuate rack is concentric with the hinge, and wherein the pinion engages an outer surface of the arcuate rack.

3. The refuse vehicle body of claim 1, further comprising:
an arcuate channel fixed to the body, a portion of the arcuate rack deployed in the channel such that the channel is configured to retain the rack in engagement with the pinion, the channel having a radius of curvature substantially identical to a radius of curvature of the rack.

4. The refuse vehicle body of claim 1, wherein the pinion comprises a pinion gear or a worm drive.

5. The refuse vehicle body of claim 1, further comprising a gear box rotationally coupling the pinion to the electric actuator.

6. The refuse vehicle body of claim 5, wherein an output shaft of the electric actuator is substantially parallel with a side of the body, and an axis of the pinion is substantially orthogonal to the side of the body.

7. The refuse vehicle body of claim 1, wherein the pinion engages one or more of an inner surface and an outer surface of the arcuate rack.

8. The refuse vehicle body of claim 1, wherein the electric actuator further comprises a brake, wherein actuation and de-actuation of the brake is configured to lock and unlock the tailgate.

9. The refuse vehicle body of claim 1, wherein the electric actuator is a first electric actuator, the pinion is a first pinion, and the arcuate rack is a first arcuate rack, the body further comprising a second electric actuator, a second pinion, and a second rack,
wherein the first and second electric actuators are configured to rotate the corresponding first and second pinions supported by corresponding first and second opposing sides of the body, the first and second pinions engaging the corresponding first and second arcuate racks fixed to first and second opposing sides of the tailgate.

10. The refuse vehicle body of claim 1, further comprising a locking assembly configured to lock the tailgate in the closed position.

11. The refuse vehicle body of claim 1, wherein the body further comprises:
a hopper configured to receive refuse;
a storage container configured to store compacted refuse; and
an ejector movable in the body and configured to compact refuse in the storage container when the tailgate is in the closed position and eject refuse from the storage container when the tailgate is in the open position.

12. The refuse vehicle body of claim 1, mounted to a vehicle chassis.

13. A refuse vehicle body comprising:
a tailgate hinged to the body, the tailgate rotatable about a hinge between a closed position and an open position;
a pin deployed on the tailgate;
a pinion rotationally coupled with the body;
a pair of racks configured to engage the pinion, the pair of racks including a first rack configured to open and close the tailgate and a second rack configured to lock and unlock the tailgate in the closed position, the second rack including a lock that engages the pin and locks the tailgate in the closed position; and
an electric actuator configured to: (i) rotate the pinion, (ii) move the first rack to open and close the tailgate in response to rotation of the pinion, and (iii) move the second rack to lock and unlock the tailgate in the closed position in response to rotation of the pinion.

14. The refuse vehicle body of claim 13, wherein the electric actuator is configured to: (i) move the second rack to disengage the lock from the pin and move the second rack to rotate the tailgate towards the open position in response to rotation of the pinion in a first direction, and (ii) move the first rack to rotate the tailgate towards the closed position and move the second rack to engage the lock with the pin when the tailgate is in the closed position in response to rotation of the pinion in a second opposite direction.

15. The refuse vehicle body of claim 13, further comprising:
a push rod deployed between and mechanically coupling the first rack and the tailgate, a first end of the push rod pivotably coupled to the tailgate and a second end of the push rod pivotably coupled to the first rack.

16. The refuse vehicle body of claim 13, wherein the first and second racks comprise first and second linear racks engaging diametrically opposing sides of the pinion.

17. The refuse vehicle body of claim 13, wherein the lock comprises a hook fixed to or integral with one end of the second rack.

18. The refuse vehicle body of claim 13, wherein the electric actuator is a first electric actuator, and the pinion is a first pinion, the body further comprising a second electric actuator and a second pinion,
wherein the first and second electric actuators are coupled to the corresponding first and second pinions that are supported by corresponding first and second opposing sides of the body, and
wherein the first and second pinions are configured to engage the corresponding first and second racks, thereby opening and closing the tailgate and locking and unlocking the tailgate.

19. A refuse vehicle body comprising:
a tailgate hinged to the body, the tailgate rotatable about a hinge between a closed position and an open position;
a worm gear;
a worm drive engaged with the worm gear; and
an electric motor configured to rotate the worm drive, thereby rotating the worm gear to open and close the tailgate.

20. A refuse vehicle body comprising:
a tailgate hinged to the body, the tailgate rotatable about a hinge between a closed position and an open position;
a pinion supported by the body;
a rack retained in engagement with the pinion, the rack being rotationally coupled with the tailgate;
a pin on the tailgate;
a lock configured to engage the pin to lock the tailgate in the closed position; and
an electric actuator configured to rotate the pinion and move the rack to: (i) open and close the tailgate and (ii) lock and unlock the tailgate in the closed position in response to rotation of the pinion.
